(19) United States
(12) Patent Application Publication
(10) Pub. No.: US 2019/0159427 A1
(43) Pub. Date: May 30, 2019

(54) ANIMAL VOLUNTARY WEIGHT LIFTING CAGE APPARATUS AND RELATED METHODS THEREOF

(71) Applicant: University of Virginia Patent Foundation, Charlottesville, VA (US)

(72) Inventor: Zhen Yan, Charlottesville, VA (US)

(73) Assignee: University of Virginia Patent Foundation, Charlottesville, VA (US)

(21) Appl. No.: 15/759,563

(22) PCT Filed: Sep. 19, 2016
(86) PCT No.: PCT/US16/52520

§ 371 Date: Mar. 13, 2018

Related U.S. Application Data
(60) Provisional application No. 62/220,065, filed on Sep. 17, 2015.
(60) Provisional application No. 62/394,581, filed on Sep. 14, 2016.

(51) Int. Cl. A01K 5/01; A01K 15/02; A01K 5/02; A01K 1/03

(52) U.S. Cl. CPC A01K 5/0142; A01K 1/031; A01K 5/0291; A01K 15/02

(57) ABSTRACT

A feeding and weight resistance apparatus for an animal that includes a platform configured to move in response to lifting force exerted by the animal onto the platform; a food repository configured to store food; and a feeding interface. The feeding interface may be configured to: impair food to be dispensed in response to retrieval force exerted by the animal, and regulate food dispensed from the food repository for a predetermined duration in response to the lifting force exerted by the animal toward the platform. A method of feeding and applying weight resistance for an animal. A method of diagnosing or evaluating an animal using the feeding and weight lifting apparatus and method for the study and application in the field of biomedicine, including but not limited thereto, the field of exercise physiology.

### RELATED APPLICATIONS

The present application claims benefit of priority under 35 U.S.C. § 119 (e) from U.S. Provisional Application Ser. No. 62/220,065, filed Sep. 17, 2015, entitled “Mouse Voluntary Weight Lifting Cage Apparatus and Related Methods Thereof” and U.S. Provisional Application Ser. No. 62/394,581, filed Sep. 14, 2016, entitled “Mouse Voluntary Weight Lifting Cage Apparatus and Related Methods Thereof;” the disclosures of which are hereby incorporated by reference herein in their entirety.

### FIELD OF THE INVENTION

The present invention relates generally to the field of biomedicine. More specifically, the invention pertains to the subfield of exercise physiology.

### OVERVIEW

An aspect of an embodiment of the present invention provides, among other things, a cage with food carrier placed outside a mouse cage separated by a plate or other surface or structure. In an embodiment, a mouse (mice) is housed in the cage whereby the mouse will need to perform plantar flexion of the hind limbs to lift the body and the plate or other surface to reach the food. This movement will be equivalent to “squats weight training” combined with standing barbell calf raises”. Accordingly, an aspect of an embodiment of the present invention provides, but not limited thereto, the first physiological resistance exercise model in mice. Moreover, an aspect of an embodiment of the present invention provides, for example, the ability to study the impacts and benefits of resistance exercise on physical performance and many disease conditions, such as heart failure, sarcopenia, diabetes, osteoporosis, chronic obstructive pulmonary disease (COPD), peripheral arterial disease (PAD), etc.

In an embodiment, an aperture is disposed on the plate for the mouse to enter its head through to reach the food and food carrier. Various apertures may be used, as well as recesses or other access areas of the plate or suitable structure for contact by the mouse.

In an embodiment, as the mouse performs plantar flexion of the hind limbs to lift the body and the plate or other surface to reach the food a sensor is activated. In an approach the sensor may be a magnetic sensor, but it should be appreciated that various types of sensors (or other feedback systems or mechanisms) may be used and are considered part of the present invention. The available and applicable sensors may, of course, be employed within the context of the invention.

It should be appreciated the device may be applicable to other subjects besides mice, such as other rodents or animals.

It should be appreciated that as discussed herein, a subject may be a mouse or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc.

It should be appreciated that the biomedicine and exercise-physiology findings, characteristics, evaluations and attributes derived from aspects of various embodiments of the present invention may be applicable to humans and other animals, for example.

An aspect of an embodiment of the present invention demonstrates, among other things, the importance of resistance training for promoting muscle function and bone density and structure, as well as for preventing deleterious impacts of aging and chronic diseases. The impact of the weightlifting model is potentially very high as this is not just a model for exercise study, but for biomedicine. An aspect of the present invention helps demonstrates that, among other things, resistance training can alter or improve the status of muscle from atrophy and dysfunction to hypertrophy and improved function.

An aspect of an embodiment of the present invention provides, among other things, an apparatus and related method that is less invasive for the subject animal and less labor intensive for the technician, doctor or researcher operating the apparatus or conducting the related method. An aspect of an embodiment helps to promote or provide the capability of large-scale studies. An aspect of an embodiment of the present invention provides the ability to vary the load and over load on the subject animal, as well as allow recovery time for the animal. An aspect of an embodiment of the present invention provides the ability to undergo a model and related method that may be free from or minimize human handling, which otherwise can cause significant amount of stress to the animals and could confound the interpretation of the findings.

An aspect of an embodiment of the present invention provides, among other things, an apparatus and related method that provides sustained and low intake feeding by the subject animal (e.g., mouse). An aspect of an embodiment of the present invention provides, among other things, an apparatus and related method that provides such an approach, for example, provides an incentive for the mouse to continue to eat—thus perform prolonged weightlifting repetitions (resistance training). Accordingly, for example, the high and prolonged repetition enables, but not limited thereto, the following nine deliverables: 1) protein synthesis, 2) gene expression, 3) glucose tolerance, 4) muscle hypertrophy, 5) improved muscle contractile function, 6) increased width of tibia and femur, 7) increased bone density, 8) improved tendon structure, and 9) promote healthy aging (e.g., increased health span and/or life span).

An aspect of an embodiment of the present invention provides, among other things, an apparatus and related method whereby the number of exercise repetitions (lifts) by a mouse far outnumbers the number of pellets retrieved by the mouse. The mouse remains insatiable; and as the mouse is not satiated due to minimal food intake, it continues with weight lifting repetitions so as to pursue food.

It should be appreciated that various sizes, dimensions, contours, rigidity, shapes, flexibility and materials of any of the components or portions of components in the various embodiments discussed throughout may be varied and utilized as desired or required. Similarly, locations and alignments of the various components may vary as desired or required.

It should be appreciated that any of the components or modules referred to with regards to any of the present invention embodiments discussed herein, may be integrally or separately formed with one another. Further, redundant functions or structures of the components or modules may be implemented.

It should be appreciated that the device and related components discussed herein may take on all shapes along the entire continual geometric spectrum of manipulation of x, y and z planes to provide and meet the anatomical, environmental, and structural demands and operational requirements. Moreover, locations and alignments of the various components may vary as desired or required. Moreover, sequences of steps may be altered as well as other activities and stations for the mouse to perform or visit.

An aspect of an embodiment of the present invention provides, among other things, a feeding and weight resistance apparatus for an animal. The apparatus may comprise: a platform configured to move in response to lifting force exerted by the animal onto the platform; a food repository including at least one surface, the food repository configured to store food; and a feeding interface. The feeding interface may be configured to: impair food to be dispensed in response to retrieval force exerted by the animal, and regulate food dispensed from the food repository for a predetermined duration in response to the lifting force exerted by the animal toward the platform.

An aspect of an embodiment of the present invention provides, among other things, a method of feeding and applying weight resistance for an animal. The method may comprise: allowing the animal to lift a platform configured to move in response to lifting force exerted by the animal onto the platform; storing food in a food repository; and allowing the animal to interface with the food repository such that a) food retrieval force exerted by the animal on food to be dispensed by the food repository is impaired, and food dispensed from the food repository is regulated for a predetermined duration in response to the lifting force exerted by the animal toward the platform.

An aspect of an embodiment of the present invention provides, among other things, a method of diagnosing or evaluating an animal. The method may comprise: providing the animal to an apparatus comprising an embodiment of the apparatus disclosed herein; allowing the animal to use an embodiment of the apparatus disclosed herein; and diagnosing or evaluating the effect of the animal due to the animal using an embodiment of the apparatus disclosed herein.

An aspect of an embodiment of the present invention provides, among other things, a feeding and weight resistance apparatus for an animal that includes a platform configured to move in response to lifting force exerted by the animal onto the platform; a food repository configured to store food; and a feeding interface. The feeding interface may be configured to: impair food to be dispensed in response to retrieval force exerted by the animal, and regulate food dispensed from the food repository for a predetermined duration in response to the lifting force exerted by the animal toward the platform. Also included is a method of feeding and applying weight resistance for an animal. Still yet, also included is a method of diagnosing or evaluating an animal using the feeding and weight lifting apparatus and method for the study and application in the field of biomedicine, including but not limited thereto, the field of exercise physiology.

These and other objects, along with advantages and features of various aspects of embodiments of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

The foregoing and other objects, features and advantages of the present invention, as well as the invention itself, will be more fully understood from the following description of preferred embodiments, when read together with the accompanying drawings

FIG. 1 provides a schematic illustration of an embodiment, generally a side view, of a feeding and weight resistance apparatus for an animal.

FIG. 2 provides a schematic illustration of an embodiment, generally a side view, of a feeding and weight resistance apparatus for an animal.

FIG. 3 provides a schematic illustration of an embodiment, generally a side view, of a feeding and weight resistance apparatus for an animal.

FIG. 4 provides a schematic illustration of an embodiment, generally a side view, of a feeding and weight resistance apparatus for an animal.

FIG. 5 provides a schematic illustration of an embodiment, generally a side view, of a feeding and weight resistance apparatus for an animal.

FIG. 6 provides a schematic illustration of an embodiment, generally a side view, of a feeding and weight resistance apparatus for an animal.

FIG. 7 provides a schematic illustration of a partial view of an embodiment, generally as a side view, of a feeding and weight resistance apparatus for an animal.

FIG. 8 provides a schematic illustration of a partial view of an embodiment, generally as a plan view, of a feeding and weight resistance apparatus for an animal.

FIG. 9 provides a schematic illustration of a partial view of an embodiment, generally as a plan view, of a feeding and weight resistance apparatus for an animal.

FIG. 10 provides a schematic illustration of a partial view of an embodiment, generally as a side view, of a feeding and weight resistance apparatus for an animal.

FIG. 11 provides a schematic illustration of a perspective view of an embodiment of a food container for use as part of an embodiment of a feeding and weight resistance apparatus for an animal (e.g., mouse).

FIG. 12 provides a schematic illustration of a plan view of an alternative embodiment of the feeding surface as shown in FIG. 11.

FIG. 13 provides a schematic illustration of a plan view of an alternative embodiment of the feeding surface as shown in FIG. 11.

FIG. 14 provides a schematic illustration of a plan view of an alternative embodiment of the feeding surface as shown in FIG. 11.

FIG. 15 provides a schematic illustration of a plan view of an embodiment of the collar to be worn by the mouse (or animal).

FIG. 16 provides a schematic illustration of a plan view of an embodiment of the collar to be worn by the mouse (or animal).

FIG. 17 is a screenshot of a graph illustrating the weightlifting activities in five days in real time.

FIG. 18 is a screenshot of a graph illustrating the calculated total weightlifting activities per night.

FIG. 19 is a screenshot of a graph illustrating a calibration curve for the added weight to the lever arm and the force measured at the lever plate (platform).

FIG. 20 is a screenshot of a graph illustrating the relationship between weightlifting activity (repeats/night) and relative resistance load in % body weight.

FIG. 21 is a screenshot of a table that shows the summary results of RNAseq data in gastrocnemius muscles (n=3 for each group) after a single night weightlifting activity.

FIG. 22 is a screenshot of a photographic depiction that shows semi-quantitative PCR data.

FIG. 23 is a screenshot of a graph illustrating * and ** that which denote p<0.05 and p<0.01.

FIG. 24 is a screenshot whereby on the left side of the screenshot there is shown a photographic depiction of a mouse during in vivo muscle contractility assay and on the right side of the screenshot there is shown a graph illustrating the in vivo muscle force measurement of the mouse (as shown in the left of screenshot).

FIG. 25 is a screenshot of a graph illustrating a representative trace of tetanic contractions of posterior muscles of the lower hindlimb.

FIG. 26 is a screenshot whereby on the left side of the screenshot there is shown a graph illustrating the normalized tetanic contractions at different stimulation frequency to the motor nerve in Con and WL mice and on the right side of the screenshot this is shown a graph illustrating the force production during repeated contractions induced by motor nerve stimulations as a fatigability test for Con and WL mice.

FIG. 27 is a screenshot whereby on the left side of the screenshot there is shown a photographic depiction of mice undergoing a treadmill running test and on the right side of the screenshot there is shown a graph illustrating the running distance of the treadmill running test in Con and WL mice (as shown on the left side of the screenshot);

FIG. 28 is a screenshot whereby on the left side of the screenshot there is shown a graph illustrating the blood glucose levels during glucose tolerance test (GTT); and on the right side of the screenshot this is shown a graph illustrating the area under the curve (AUC) of the GTT test results (from test as shown in left side of the screenshot

FIG. 29 is a screenshot whereby on the left side of the screenshot there are panels (top & bottom) that show representative MRI depictions of the whole body at the position of the mid left lower hindlimbs of the Con and WL mice, respectively. Further, on the right side of the screenshot of FIG. 29 there is shown panels (top & bottom) that provide the corresponding enlarged images of the left hindlimbs in Con and WL mice, respectively (as shown on the left side of the screenshot).

FIG. 30 is a screenshot whereby on the left side of the screenshot there is shown a graph illustrating the quantitative data of the cross-sectional area of the left lower hindlimbs measured by MRI, and on the right side of the screenshot this is shown a graph illustrating the wet weight of the lower hindlimb muscles.

FIG. 31 is a screenshot whereby on the left side of the screenshot there is a panel that shows SUnSet assay of incorporated puromycin in gastrocnemius; and on the right side of the screenshot there is shown a graph illustrating an increased puromycin signals, indicative of protein synthesis, in WL mice compared with Con mice.

### DETAILED DESCRIPTION OF EXEMPLARY EMBODIMENTS OF THE PRESENT INVENTION

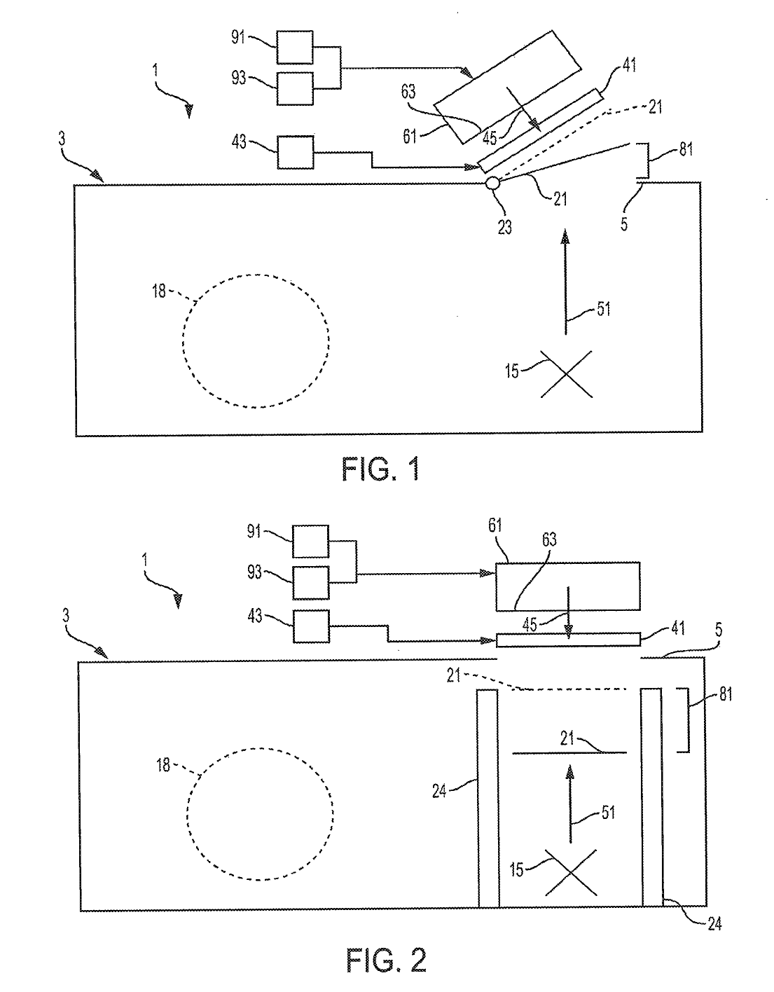

FIG. 1 provides a schematic illustration of an embodiment, generally a side view, of a feeding and weight resistance apparatus 1 for an animal 15, quite typically a mouse, for example. The apparatus 1 may include a platform 21 configured to move in response to lifting force exerted by the mouse 15 toward the platform 21. Also, included is a food repository 61 that may have a variety of configurations including at least one surface. The food repository 61 is configured to store food for a variety of durations. The apparatus 1 may further include a feeding interface 41 configured to: impair or inhibit food retrieval force (for example see force arrow generally depicted as reference 45) exerted by the mouse (animal), and regulate food dispensed from the food repository 61 for a predetermined duration in response to the lifting force (for example see force arrow generally depicted as reference 51) exerted by the mouse (animal) onto the platform 21. The mouse 15 will need to perform plantar flexion of the hind limbs to lift the body and the platform 21 or other surface to reach the food in the food repository 61. This movement by the mouse will be equivalent to “squats weight training” combined with standing barbell calf raises”. Accordingly, an aspect of an embodiment of the present invention provides, but not limited thereto, the unique physiological resistance exercise model in mice. As the mouse 15 applies the lifting force 51 against the platform 21 the platform 21 can pivot on the hinge 23 (or pivot or the like). The platform 21 apparatus 1 is configured to receive the head of the mouse 15 to further define the feeding interface 41. The apparatus 1 may further include a sensor 81 whereby the sensor 81 may be configured to detect the movement of the platform 21 in response to the lifting force 51 exerted by the animal 15 directed toward the platform 21. The sensor may be a variety of mechanical, electrical, and/or visual sensors. The results obtained or acquired by the sensors may be recorded or transmitted locally and/or remotely to a processor, computer, network, PDA, display, and/or other device, system or equipment.

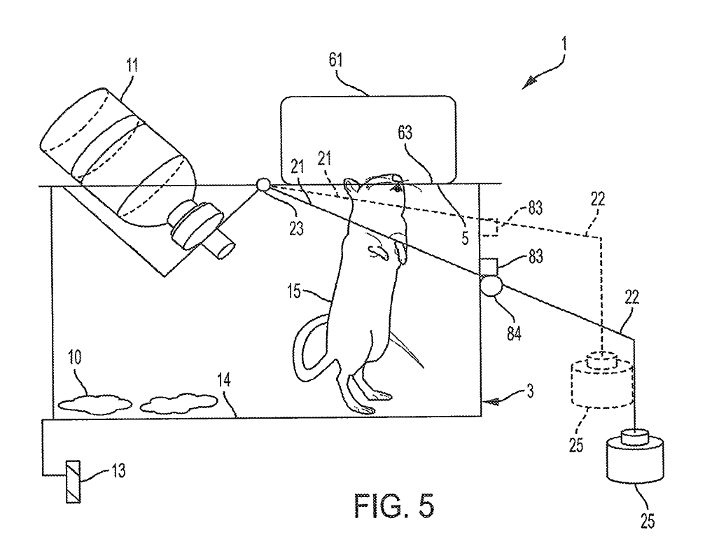

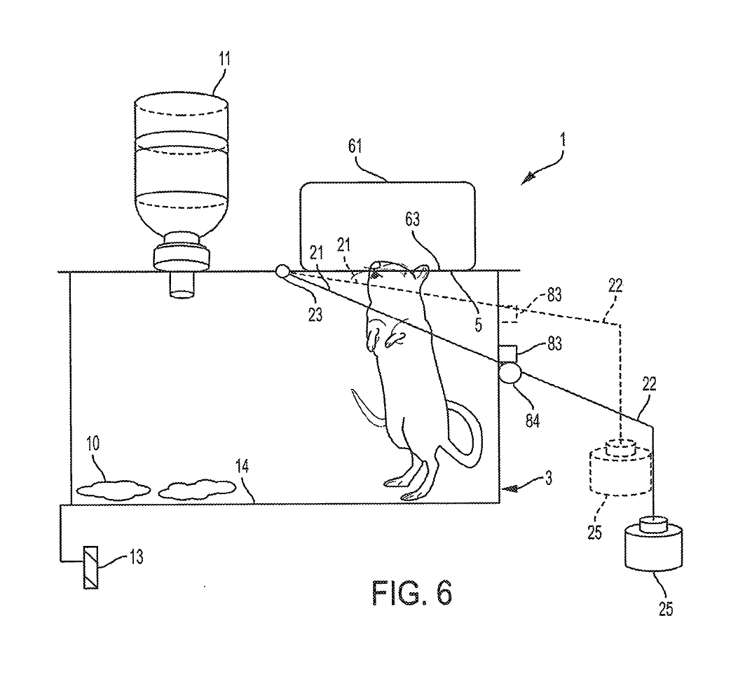

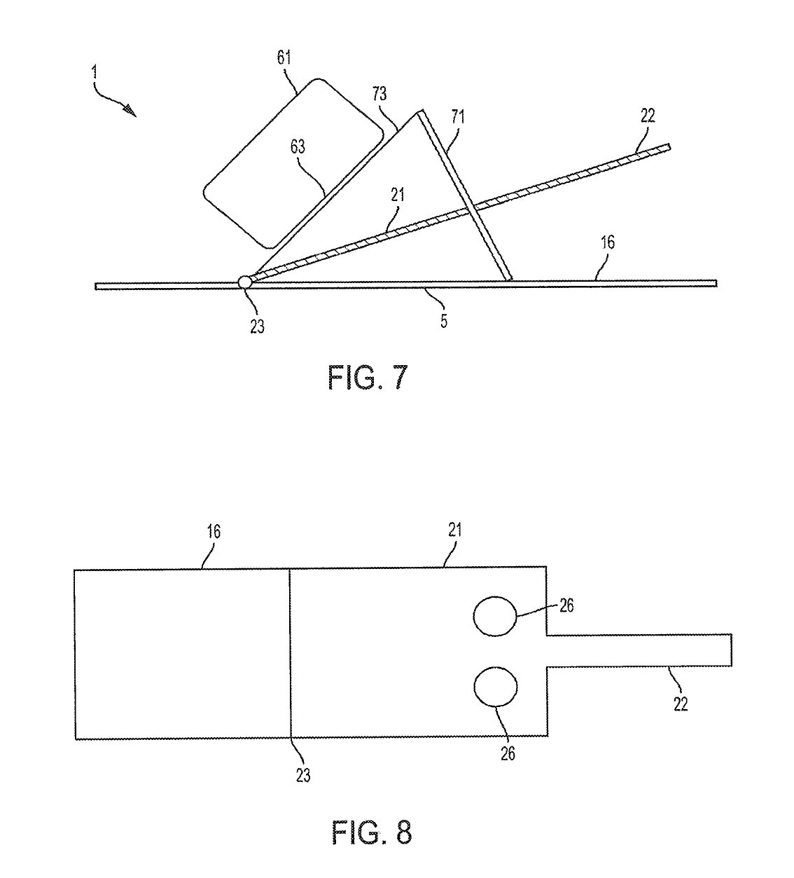

Still referring to FIG. 1, which provides a schematic illustration of an embodiment, generally a side view, of a feeding and weight resistance apparatus 1, the food repository 61 may include a feeding surface 63 closest to the platform 21 to further define the feeding interface 41, wherein said feeding surface 63 of said food repository 61 comprises one or more apertures for receiving the mouth of the mouse 15 and dispensing food to the mouse 15. In some embodiments, the mouse 15 may wear a collar (for example, shown in FIGS. 15-16) configured to receive the head of the mouse 15 configured to be worn by the mouse; and wherein the collar may further defines the feeding interface 41. The apparatus 1 may include a housing 3 having at least one surface to contain the mouse 15. The housing 3 may include an access area 5 for the mouse 15 to have access to the food repository 61. In an approach, the apparatus 1 includes the access area 5, which may be configured as a feeding vent 71 (not show in instant figure, but see FIGS. 7 and 10, for example). The access area 5 may be configured for receiving the head of the mouse 15. As shown in FIGS. 7 and 10, the apparatus 1 may include an access area 5 configured as a feeding vent 71 that includes a feeding surface 73 to further define said feeding interface 41, wherein said feeding surface 71 of the access area 5 or feeding vent 5 may comprises one or more apertures for receiving the mouth and/or head of the mouse and for dispensing food to the mouse. In some embodiments, the access area 5, may substantially coincide with the top surface of the housing 3, as shown in FIGS. 5-6, for example. In an embodiment, the apparatus 1 may also include a food supplier device 91 configured to advance food to said food repository 61 or the feeding interface 41. Additionally, the apparatus 1 may also include a processor 93 for controlling the supplier device 91. The processor 93 may be a processor, controller, and/or motor. The motor may be used for dropping or advancing the food to the container 61, feeding interface 41, or housing 3. The processor and controller may track or monitor the food and nutrition being retrieved or distributed. In an embodiment, the apparatus 1 may further include a processor 43 for controlling said feeding interface 41. For example, electro-mechanical features may be implemented on portions of the feeding interface 41 to adjust or manipulate the performance, activity, tolerances, and/or of food distribution and retrieval associated with the feeding interface 41. The apparatus 1 may be configured wherein any dispensing of food to the mouse or retrieval of food by the mouse is inhibited if duration is outside a specified time range. The processors, controllers, and motors may be configured and programmed to apply other parameters and conditions associated with dispensing of food to the mouse or retrieval of food by the mouse. The processors, controllers, and motors may be configured and programmed to apply other parameters and conditions to study the biomedicine and exercise physiology aspects of the animal (e.g. mouse). The apparatus 1 may also be provided with a running wheel 18 or other equipment for endurance or cardiovascular training.

FIG. 2 provides a schematic illustration of an embodiment, generally a side view, of a feeding and weight resistance apparatus 1 for an animal 15, quite typically a mouse, for example. FIG. 2 may be considered substantially the same as FIG. 1, but instead of the platform 21 pivoting or partially rotating on a hinge or pivot (or the like), the platform of FIG. 2 advances or traverses up and down (back and forth) substantially in a relative linear alignment on a track 24 or guide or the like. A variety of transport, lifting, aerobic (cardiovascular) and movement mechanisms and systems may be implemented to achieve the operation and the biomedicine and exercise physiology objectives of the apparatus.

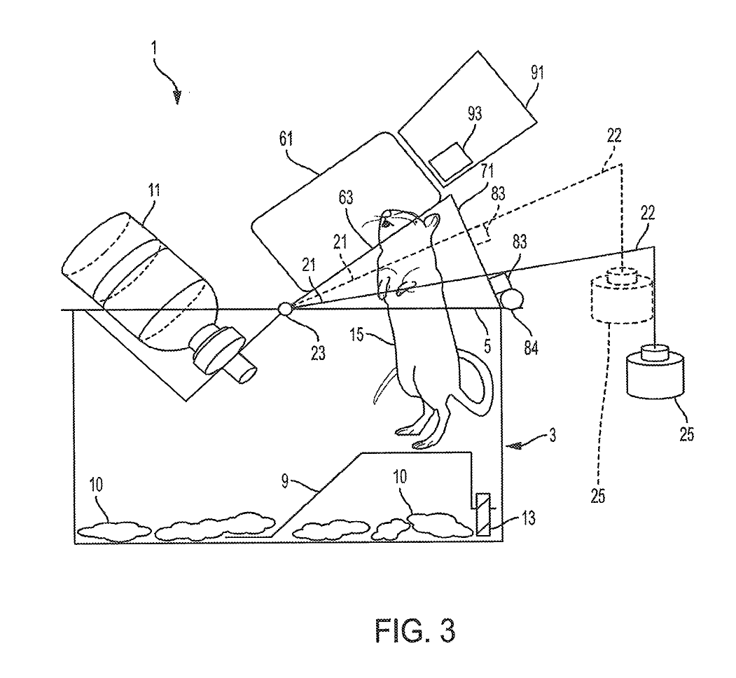

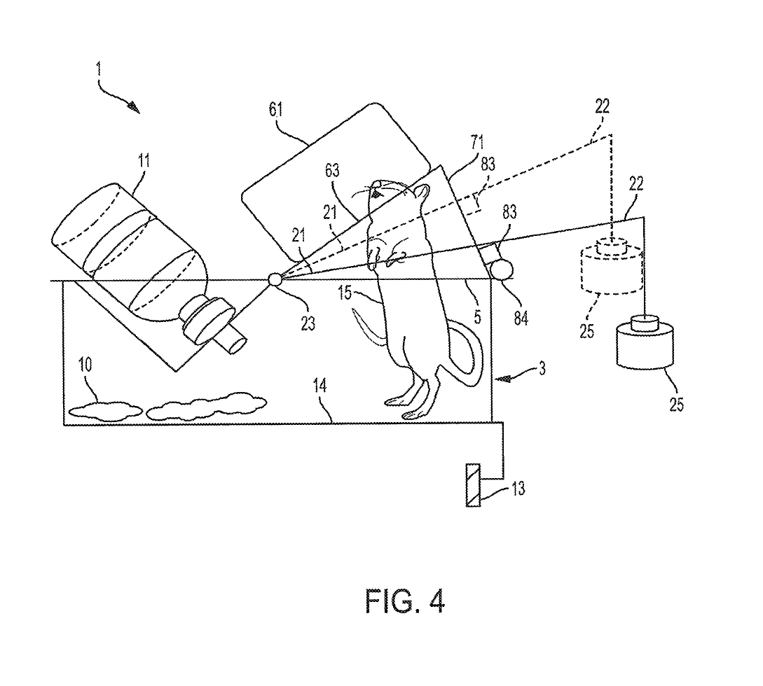

FIGS. 3-6 provide schematic illustrations of various embodiments, generally a side view, of a feeding and weight resistance apparatus 1 for an animal 15, quite typically a mouse, for example. The apparatus 1 may include a platform 21 configured to move in response to lifting force exerted by the mouse 15 toward the platform 21. Also, included is a food repository 61 that may a variety of configurations including at least one surface. The food repository 61 is configured to store food for a variety of durations. The food repository 61 may include a feeding surface 63 closest to platform 21. The feeding surface 63 is configured to impair or inhibit food retrieval force (for example see force retrieval generally depicted as an arrow referenced as 45 in FIGS. 1-2) exerted by the mouse, and therefore regulate the food dispensed from the food repository 61 for a predetermined duration in response to the lifting force (for example see force arrow generally depicted as reference 51 in FIGS. 1-2) exerted by the mouse toward the platform. The mouse 15 will need to perform plantar flexion of the hind limbs to lift the body and the platform 21 or other surface to reach the food in the food repository 61. This movement will be equivalent to “squats weight training” combined with standing barbell calf raises”. Accordingly, an aspect of an embodiment of the present invention provides, but not limited thereto, the unique physiological resistance exercise model in mice. As the mouse 15 applies the lifting force 51 toward the platform 21, the platform 21 can pivot on the hinge 23 (or pivot or the like). The platform 21 apparatus 1 is configured to receive the head of the mouse 15. The apparatus 1 may further include a sensor 81 whereby the sensor 81 may be configured to detect the movement of the platform 21 in response to the lifting force 51 exerted by the animal 15 directed toward the platform 21. The sensor may be a variety of mechanical, electrical, and/or visual sensors. The results obtained or acquired by the sensors may be recorded or transmitted locally and/or remotely to a processor, computer, network, PDA, display, and/or other device, system or equipment. The apparatus 1 may include an adjustable ramp 9 and/or adjustable floor 14 that is controllable or adjustable by an actuator 13 or the like. The platform 21 may have a variety of sizes, contours, and configurations, including for example, a lever portion 22. A weight 25 (or other external force or equipment or device) may optionally hang off of the lever 22 or platform 21 to provide additional or external weight resistance against the mouse. Other external forces, equipment, systems or devices may be applied to or implemented with the platform (or apparatus) as well. Without external weight then the force exhibited by the mouse is associated with its own body weight when performing resistance exercises (e.g., squats).

Still referring to FIGS. 3-6, which provide a schematic illustration of an embodiment, generally a side view, of a feeding and weight resistance apparatus 1, the feeding surface 63 of the food repository 61 may include one or more apertures for receiving the mouth of the mouse 15 and dispensing food to the mouse 15. In some embodiments, the mouse 15 may wear a collar 7 (for example, shown in FIGS. 15-16) configured to receive the head of the mouse 15 and that which is configured to be worn by the mouse 15. The apparatus 1 may include a housing 3 having at least one surface to contain the mouse 15. The housing 3 may include an access area 5 for the mouse 15 to have access to the food repository 61. In an approach, the apparatus 1 includes the access area 5 which may be configured as a feeding vent 71 (see FIGS. 3, 4, 7 and 10, for example). The access area 5 may be configured for receiving the head of the mouse 15. The apparatus 1 may include an access area 5 configured as a feeding vent 71 that includes a feeding surface 73 to further define said feeding interface 41, wherein said feeding surface 73 of said the access area 5 the feeding vent 71 may comprises one or more apertures for receiving the mouth of the mouse and for dispensing food to the mouse. In some embodiments, the access area 5, may substantially coincide with the top surface of the housing 3, as shown in FIGS. 5-6, for example. In an embodiment, the apparatus 1 may also include a food supplier device 91 configured to advance food to said food repository 61 or said feeding interface 41. Additionally, the apparatus 1 may also include a processor 93 for controlling the supplier device 91. The processor 93 may be a processor, controller, and/or motor. The motor may be used for dropping or advancing the food to the container 61 or housing 3. The processor and controller may track or monitor the food and nutrition being retrieved or distributed. In an embodiment, the apparatus 1 may further include a processor 43 (not shown in instant figures) for controlling different sub-components of the apparatus 1, such as the: platform 21, feeding surface 63 of the food repository 61, collar 7, or feeding surface of the feeding vent 71. For example, electro-mechanical features may be implemented on portions of the aforementioned list of sub-components to adjust or manipulate the performance, activity, tolerances, and/or of food retrieval associated with the sub-components. The apparatus 1 may be configured wherein any dispensing of food to the mouse or retrieval of food by the mouse is inhibited if duration is outside a specified time range. The processors, controllers, and motors may be configured and programmed to apply other parameters and conditions associated with dispensing of food to the mouse or retrieval of food by the mouse. The processors, controllers, and motors may be configured and programmed to apply other parameters and conditions to study the biomedicine and exercise physiology aspects of the animal (e.g. mouse).

FIG. 7 provides a schematic illustration of a partial view of an embodiment, generally as a side view, of a feeding and weight resistance apparatus 1 for an animal. The schematic illustration includes a portion of the top surface 16 of housing or cage (not shown), or the like. Also shown is the platform 21, lever portion 22 of a platform 21, hinge 23, feeding vent 71 having a feeding surface 73 that is aligned with or in communication with a housing access 5. Finally, a food container 61 having feeding surface 63 is in communication with the feeding vent 71. The feeding vent 71 may have feeding surface 73, whereby the feeding surface 73 may be wide open or have a variety of configurations, such as those associated with the feeding surface of food container 61.

FIG. 8 provides a schematic illustration of a partial view of an embodiment, generally as a plan view, of a feeding and weight resistance apparatus for an animal. The schematic illustration includes a portion of the top surface 16 of housing or cage (not shown), or the like. Also shown is the platform 21, lever portion 22 of a platform 21, hinge 23, and apertures 26 of the platform 21. It should be appreciated that one or more apertures 26 may be implemented with the platform. The apertures 26 may have a variety of contours, shapes, dimensions and sizes. The platform 21 may be a variety of shapes, sizes, dimensions, and contours to accommodate the mouse being able to lift and engage the platform. The platform may be configured whereby the apertures may be resultant from a grid or lattice to define apertures so as to accommodate the mouse. The platform may be a configuration of various spans, tubes, segments or bars to accommodate the mouse. Other geometric configurations are considered part of the invention, and may be employed within the context of the invention for providing access to the mouse to the platform.

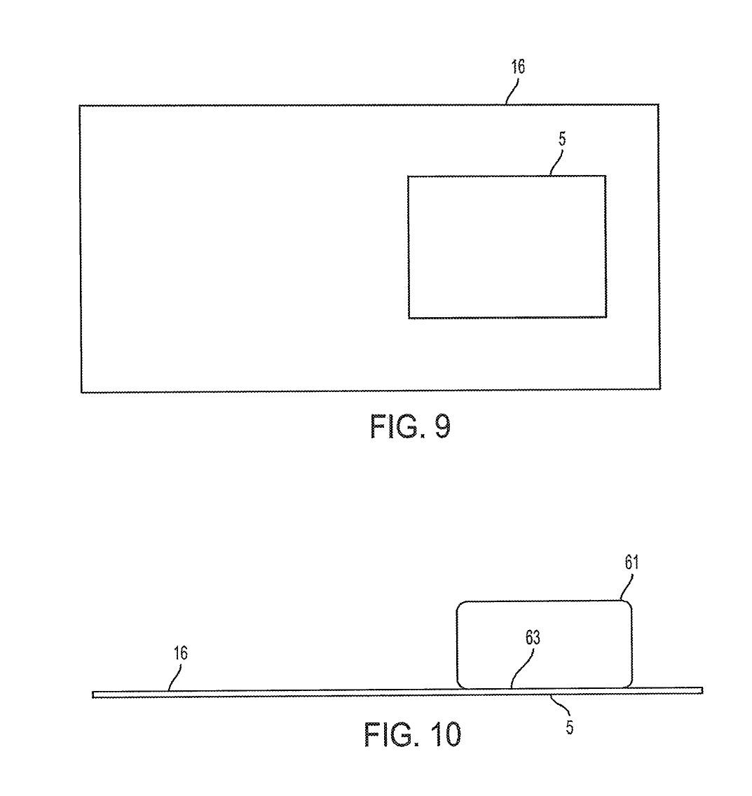

FIG. 9 provides a schematic illustration of a partial view of an embodiment, generally as a plan view, of a feeding and weight resistance apparatus for an animal. The schematic illustration includes a portion of the top surface 16 of housing or cage (not shown), or the like, as well as a housing access 5. The housing access 5 may provide communication between the housing, mouse, feeding vent, food container, as well as other areas or equipment associated with the apparatus.

FIG. 10 provides a schematic illustration of a partial view of an embodiment, generally as a side view, of a feeding and weight resistance apparatus for an animal. The schematic illustration includes a portion of the top surface 16 of housing or cage (not shown), or the like. Also shown is a food container 61 having feeding surface 63 that is in communication with an access area 5 of the top surface or apparatus.

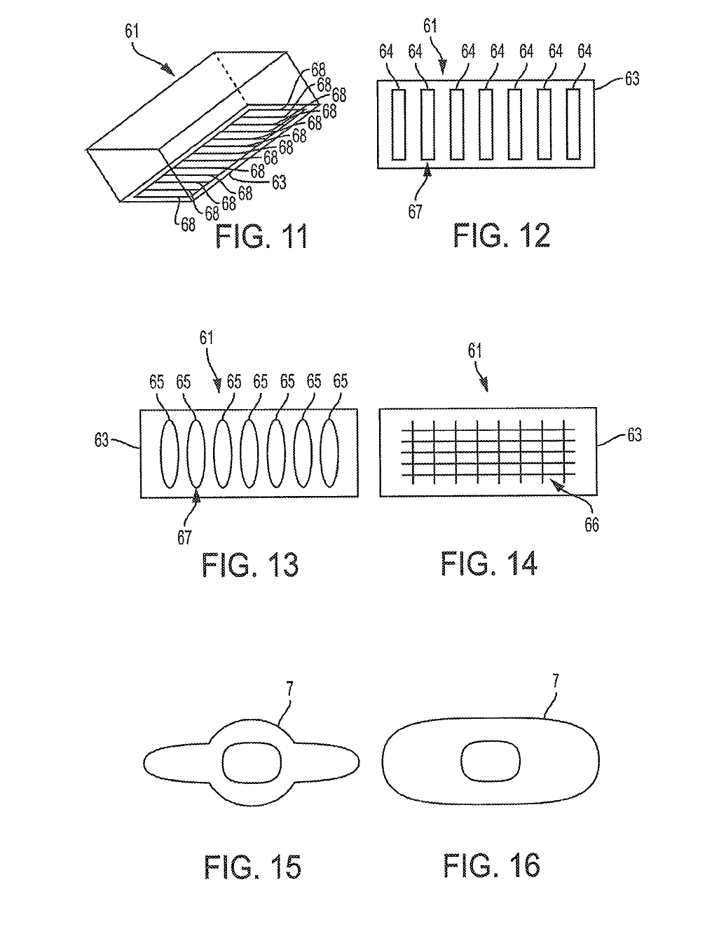

FIG. 11 provides a schematic illustration of a perspective view of an embodiment of a food container 61 for use as part of an embodiment of a feeding and weight resistance apparatus for an animal (e.g., mouse). The schematic illustration perspective view includes the food container 61 having a feeding surface 63 intend to be in communication with a feeding vent, access area, housing, or other portions, equipment, devices, systems, or structures of the apparatus. In an embodiment the feeding surface 63 may include a plurality of wires 68 or other spans or the like.

FIG. 12 provides a schematic illustration of a plan view of an alternative embodiment of the feeding surface 63 as shown in FIG. 11. This instant embodiment provides the feeding surface 63 having a plurality of slots 64 or other grooves or channels, or the like so as to form a grate 67.

FIG. 13 provides a schematic illustration of a plan view of an alternative embodiment of the feeding surface 63 as shown in FIG. 11. This instant embodiment provides the feeding surface 63 having a plurality of oval slots 64 or other grooves or channels, or the like so as to form a grate 67.

FIG. 14 provides a schematic illustration of a plan view of an alternative embodiment of the feeding surface 63 as shown in FIG. 11. This instant embodiment provides the feeding surface 63 having a plurality cross wires (or other cross-spans) to form a mesh 66. Similar patterns could include weaves or lattices. The slots, grooves, wire spacing and wire thickness in FIGS. 12-14 may have a variety of contours, sizes, dimensions, density and shapes to account for the dispensing and retrieval forces and operation.

Although not shown, the feeding vent 71 may have a feeding surface 73, whereby the feeding surface 73 may be wide open or have a variety of configurations, such as those associated with the feeding surface of food container 61, or some combination thereof. Similarly, although not shown, the access area 5 may have a feeding surface whereby its feeding surface may be wide open or have a variety of configurations, such as those associated with the feeding surface of food container 61, or some combination thereof.

FIGS. 15-16 provide a schematic illustration of plan views of alternative and non-limiting exemplary embodiments of the collar 7 to be worn by the mouse (or animal). The wing portions may be configured to sit or at least partially coincide with the shoulders, while the hole or opening provides access to slip the head through. The opening/passage on the collar 7 may be enclosed or partially open (e.g., C-shaped). It should be appreciated that the collar and platform may be integrally formed with one another, or separate components.

### EXAMPLES

Practice of an aspect of an embodiment (or embodiments) of the invention will be still more fully understood from the following examples and experimental results, which are presented herein for illustration only and should not be construed as limiting the invention in any way.

### Example and Experimental Results Set No. 1

The activity of a mouse in use of an embodiment of the present invention cage was observed. For example, the counts and repetitions represent the incidents that the mouse activated the sensor by pursuing the food/food carrier.

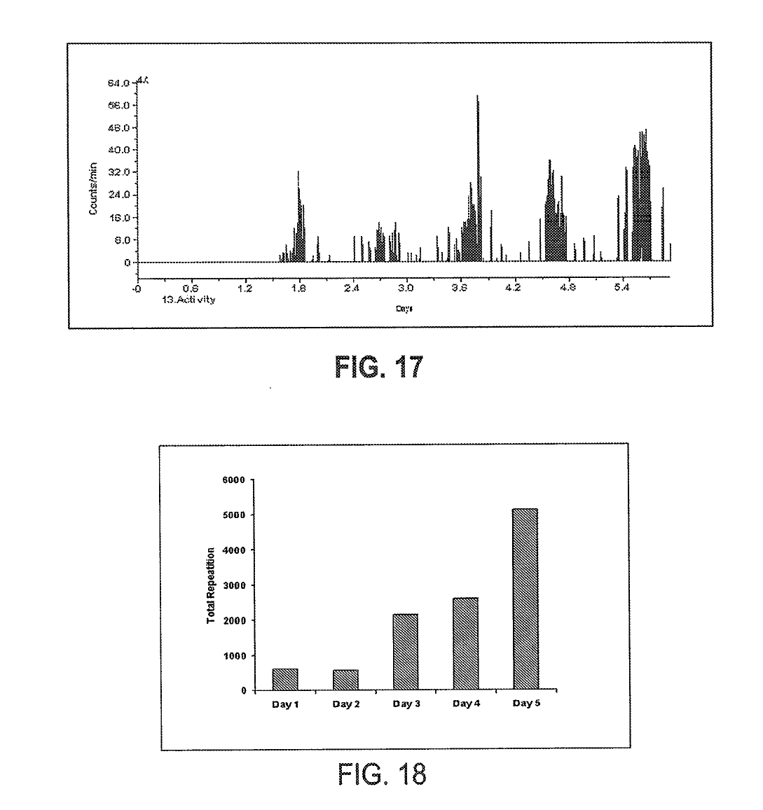

FIG. 17 is a screenshot of a graph illustrating the weightlifting activities in five days in real time. The spikes represent the counts of pushes per minute (the computer collected data every 5 min and the present inventor recalculated to express as repeats per minute). The weightlifting activity increased gradually over the 5 days, suggesting that the mouse got better in using it.

FIG. 18 is a screenshot of a graph illustrating the calculated total weightlifting activities per night. As this is early prototype test for the cages with no additional resistance load, the mouse pushed a lot. Later, when the present inventor carefully calibrated the cages and gradually increased the load according to the body weight, the number of repeats per night is in reverse relationship with the external load (See the screenshot illustrating the graph of FIG. 20).

### Example and Experimental Results Set No. 2

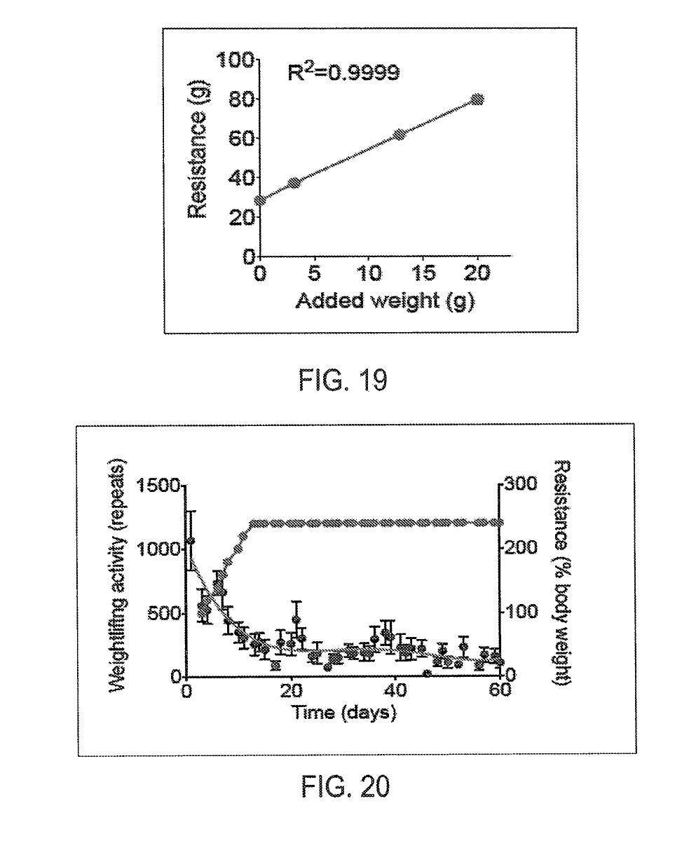

FIG. 19 is a screenshot of a graph illustrating a calibration curve for the added weight to the lever arm and the force measured at the lever plate (platform) where the resistance will be exerted to the mice (n=13). For all the experiments in this set, weights were added according to the calibration curve for each individual cage and mouse to achieve desired relative resistance load (relative to body weight).

### Example and Experimental Results Set No. 3

FIG. 20 is a screenshot of a graph illustrating the relationship between weightlifting activity (repeats/night) and relative resistance load in % body weight (n=6) during 8 weeks of weightlifting training. This screenshot shows the evidence of the feasibility of the designed cage. The circle symbol denotes the resistance on right side axis. The circle & bar symbol denotes the weightlifting activity on the left axis, with the solid line being its normalized curve.

### Example and Experimental Results Set No. 4: Gene Expression Response to a Single Bout of Weightlifting

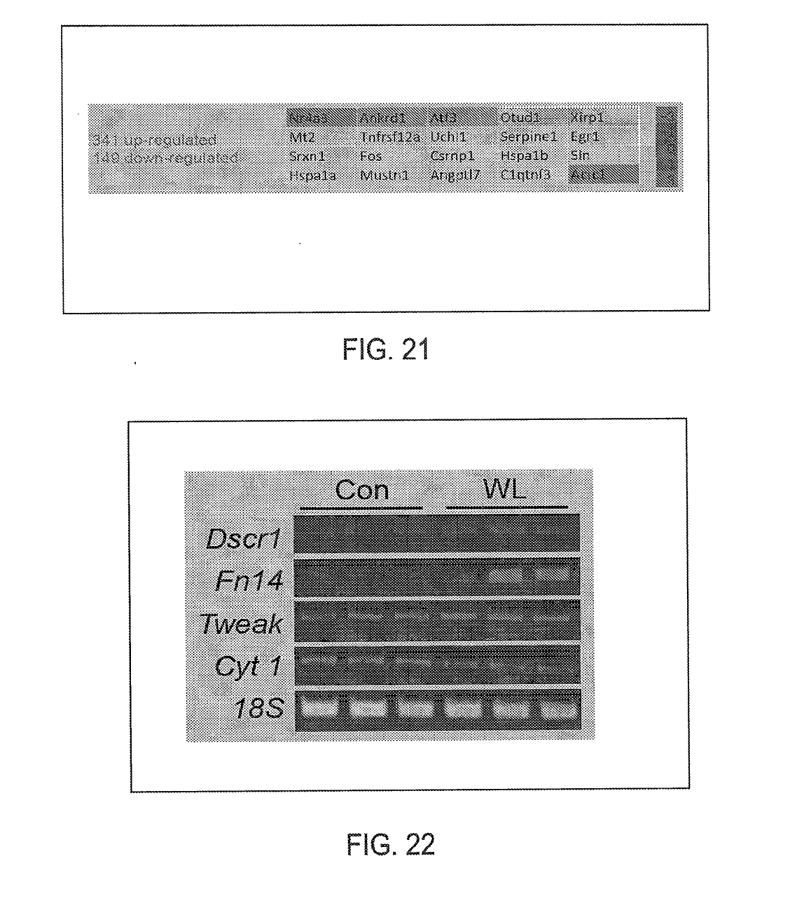

FIG. 21 is a screenshot of a table that shows the summary results of RNAseq data in gastrocnemius muscles (n=3 for each group) after a single night weightlifting activity of an average of 419 repeats (a complete list of 490 genes is provided as a separate Microsoft Excel file).

FIG. 22 is a screenshot of a photographic depiction that shows semi-quantitative PCR data of Dscr1, Fn14, Tweak, Cyt c (typo as Cyt 1) genes in gastrocnemius muscles of control (Con) and weightlifting (WL) mice.

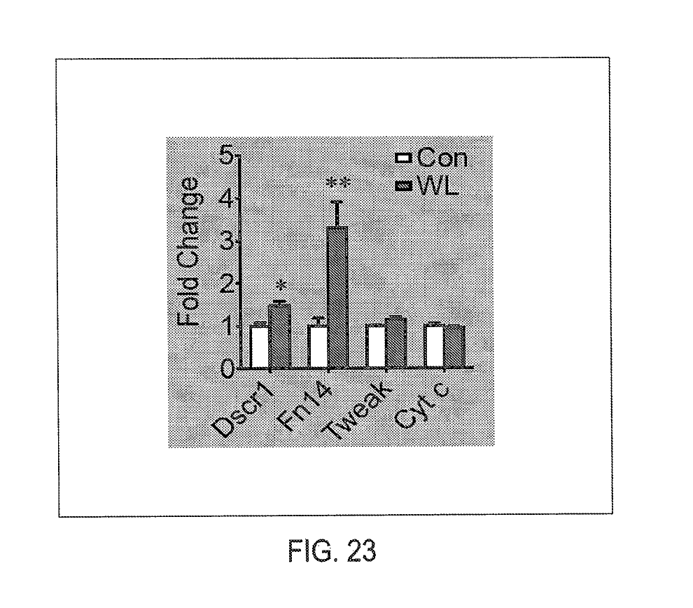

FIG. 23 is a screenshot of a graph illustrating * and ** that which denote p<0.05 and p<0.01 (n=3-4 for each group), respectively. These findings show the evidence of altered gene expression in recruited muscles after a single bout of weightlifting activities.

### Example and Experimental Results Set No. 5: Contractile and Metabolic Adaption in Response to Resistance Training

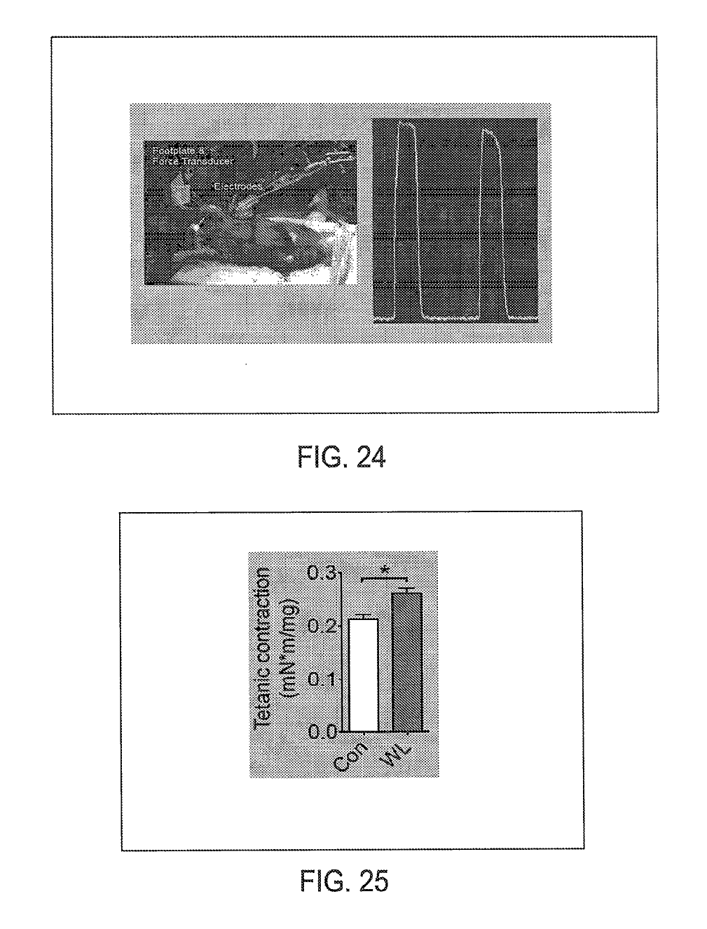

FIG. 24 is a screenshot whereby on the left side of the screenshot there is shown a photographic depiction of a mouse during in vivo muscle contractility assay and on the right side of the screenshot there is shown a graph illustrating the in vivo muscle force measurement of the mouse (as shown in the left of screenshot).

FIG. 25 is a screenshot of a graph illustrating a representative trace of tetanic contractions of posterior muscles of the lower hindlimb after 8 weeks of weightlifting training (WL) compared with sedentary control mice (Con). * denotes p<0.05 (n=4).

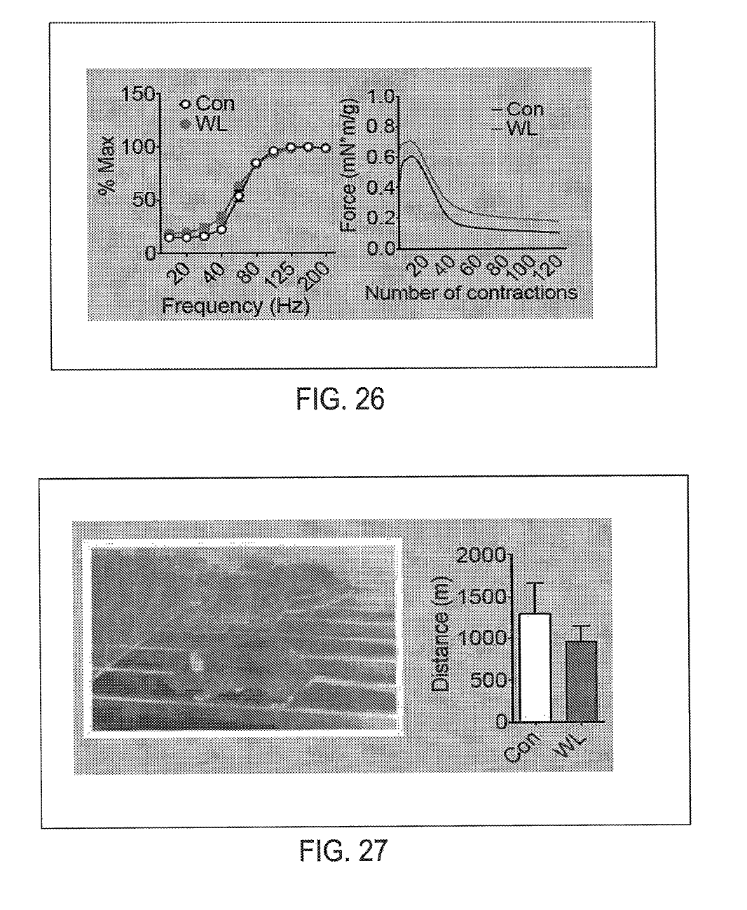

FIG. 26 is a screenshot whereby on the left side of the screenshot there is shown a graph illustrating the normalized tetanic contractions at different stimulation frequency to the motor nerve in Con and WL mice and on the right side of the screenshot this is shown a graph illustrating the force production during repeated contractions induced by motor nerve stimulations as a fatigability test for Con and WL mice.

FIG. 27 is a screenshot whereby on the left side of the screenshot there is shown a photographic depiction of mice undergoing a treadmill running test and on the right side of the screenshot there is shown a graph illustrating the running distance of the treadmill running test in Con and WL mice (as shown on the left side of the screenshot);

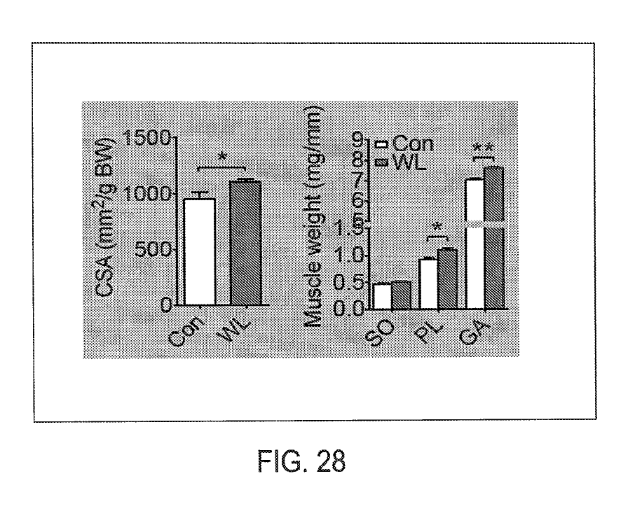

FIG. 28 is a screenshot whereby on the left side of the screenshot there is shown a graph illustrating the blood glucose levels during glucose tolerance test (GTT), ** denotes p<0.01 vs WL at each time point (n=5); and on the right side of the screenshot this is shown a graph illustrating the area under the curve (AUC) of the GTT test results (from test as shown in left side of the screenshot). * denotes p<0.05 (n=5). As such, these findings (in the screenshots found in FIGS. 24-27) provide evidence, among other things, of improved muscle contractile function and whole body glucose metabolism after 8 weeks of weightlifting training.

### Example and Experimental Results Set No. 6: Skeletal Muscle Hypertrophy and Increased Protein Synthesis in Response to Resistance Training

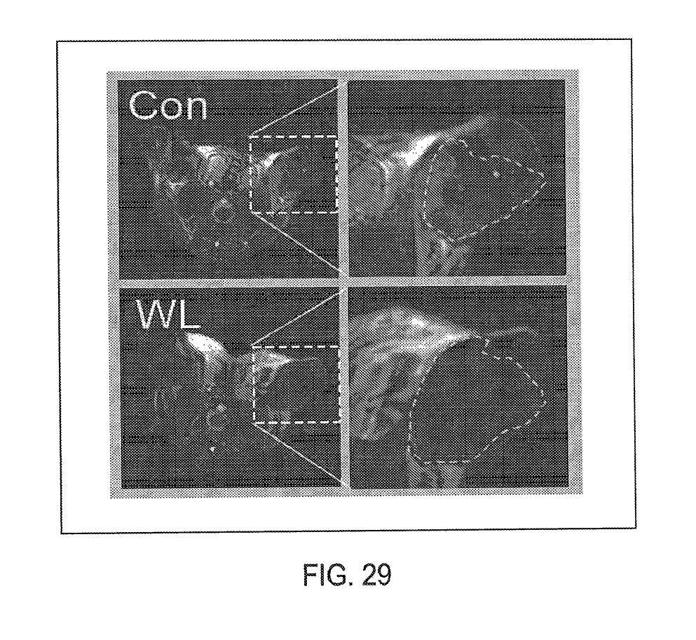

FIG. 29 is a screenshot whereby on the left side of the screenshot there are panels (top & bottom) that show representative MRI depictions of the whole body at the position of the mid left lower hindlimbs of the Con and WL mice, respectively. Further, on the right side of the screenshot of FIG. 29 there is shown panels (top & bottom) that provide the corresponding enlarged images of the left hindlimbs in Con and WL mice, respectively (as shown on the left side of the screenshot).

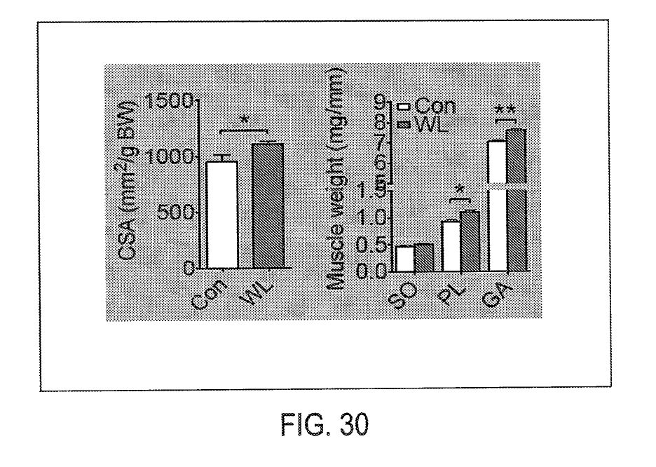

FIG. 30 is a screenshot whereby on the left side of the screenshot there is shown a graph illustrating the quantitative data of the cross-sectional area of the left lower hindlimbs measured by MRI (* denotes p<0.05; n=5), and on the right side of the screenshot this is shown a graph illustrating the wet weight of the lower hindlimb muscles (SO, soleus; PL, plantaris; GA, gastrocnemius; * and ** denotes p<0.05 and p<0.01, respectively).

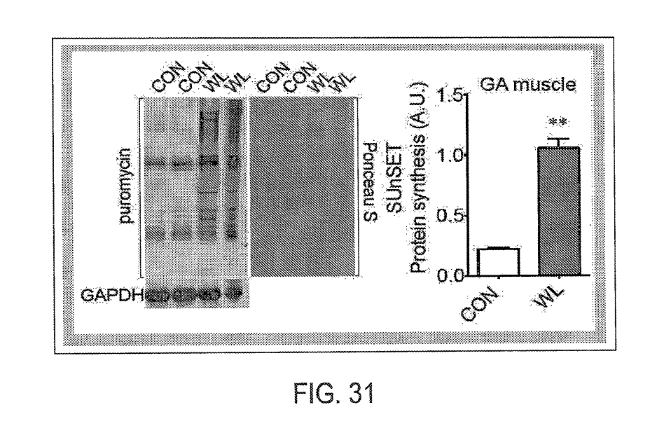

FIG. 31 is a screenshot whereby on the left side of the screenshot there is a panel that shows SUnSet assay of incorporated puromycin in gastrocnemius muscles following 8 weeks of weightlifting. ** denotes p<0.01 (n=5); and on the right side of the screenshot there is shown a graph illustrating an increased puromycin signals, indicative of protein synthesis, in WL mice compared with Con mice.

As such, these findings (in this screenshot and the screenshots shown in FIGS. 29-30) provide direct evidence of muscle hypertrophy (enlarged muscle) and increased protein synthesis.

### ADDITIONAL EXAMPLES

Example 1. An aspect of an embodiment of the present invention provides, among other things, a feeding and weight resistance apparatus for an animal. The apparatus may comprise: a platform configured to move in response to lifting force exerted by the animal onto the platform; a food repository including at least one surface, the food repository configured to store food; and a feeding interface. The feeding interface may be configured to: impair food to be dispensed in response to retrieval force exerted by the animal, and regulate food dispensed from the food repository for a predetermined duration in response to the lifting force exerted by the animal toward the platform.

Example 2. The apparatus of example 1, wherein the platform is configured to receive the head of the animal to further define the feeding interface.

Example 3. The apparatus of example 2, wherein the at least one surface of the food repository includes a feeding surface to further define the feeding interface, wherein the feeding surface of the food repository comprises one or more apertures for receiving the mouth of the animal and dispensing food to the animal.

Example 4. The apparatus of example 3 (as well as subject matter in whole or in part of example 2), further comprises a collar configured to receive the head of the animal configured to be worn by the animal, wherein the collar further defines the feeding interface.

Example 5. The apparatus of example 2 (as well as subject matter of one or more of any combination of examples 2-4, in whole or in part), further comprising a housing having at least one surface to contain the animal.

Example 6. The apparatus of example 5 (as well as subject matter of one or more of any combination of examples 2-4, in whole or in part), wherein the at least one surface of the housing includes an access area for the animal to have access to the food repository.

Example 7. The apparatus of example 6 (as well as subject matter of one or more of any combination of examples 2-5, in whole or in part), wherein the access area of housing includes a feeding surface to further define the feeding interface, wherein the feeding surface of the access area comprises one or more apertures for receiving the mouth of the animal and for dispensing food to the animal.

Example 8. The apparatus of example 6 (as well as subject matter of one or more of any combination of examples 2-5 and 7, in whole or in part), wherein the access area includes a feeding vent.

Example 9. The apparatus of example 8 (as well as subject matter of one or more of any combination of examples 3-7, in whole or in part), wherein the access area of the feeding vent includes a feeding surface to further define the feeding interface, wherein the feeding surface of the access area comprises one or more apertures for receiving the mouth of the animal and for dispensing food to the animal.

Example 10. The apparatus of example 2 (as well as subject matter of one or more of any combination of examples 3-9, in whole or in part), wherein the dispensing of food is inhibited if weight of food dispensed is outside a specified weight range or if rate of food dispensed is outside a specified rate range.

Example 11. The apparatus of example 2 (as well as subject matter of one or more of any combination of examples 3-10, in whole or in part), wherein the dispensing of food is inhibited if duration is outside a specified time range.

Example 12. The apparatus of example 1 (as well as subject matter of one or more of any combination of examples 2-11, in whole or in part), further comprising a food supplier device configured to advance food to the food repository or the feeding interface.

Example 13. The apparatus of example 12 (as well as subject matter of one or more of any combination of examples 2-11, in whole or in part), further comprising a processor for controlling the supplier device.

Example 14. The apparatus of example 13 (as well as subject matter of one or more of any combination of examples 2-12, in whole or in part), further comprising a processor for controlling the feeding inter face.

Example 15 The apparatus of example 1 (as well as subject matter of one or more of any combination of examples 2-14, in whole or in part), further comprising a sensor, the sensor configured to detect the movement of the platform in response to the lifting force exerted by the animal onto the platform.

Example 16. The apparatus of claim 1 (as well as subject matter of one or more of any combination of examples 2-15, in whole or in part), wherein the animal is a mouse.

Example 17. The apparatus of example 1, further comprising additional weight force applied to the platform generally opposite of the lifting force.

Example 18. An aspect of an embodiment of the present invention provides, among other things, a method of feeding and applying weight resistance for an animal. The method may comprise: allowing the animal to lift a platform configured to move in response to lifting force exerted by the animal onto the platform; storing food in a food repository; and allowing the animal to interface with the food repository such that a) food retrieval force exerted by the animal on food to be dispensed by the food repository is impaired, and food dispensed from the food repository is regulated for a predetermined duration in response to the lifting force exerted by the animal toward the platform.

Example 19. An aspect of an embodiment of the present invention provides, among other things, a method of diagnosing or evaluating an animal. The method may comprise: providing the animal to an apparatus comprising an embodiment of the apparatus disclosed herein (as well as subject matter of one or more of any combination of examples 1-17, in whole or in part); allowing the animal to use an embodiment of the apparatus disclosed herein (as well as subject matter of one or more of any combination of examples 1-17, in whole or in part); and diagnosing or evaluating the effect of the animal due to the animal using an embodiment of the apparatus disclosed herein (as well as subject matter of one or more of any combination of examples 1-17, in whole or in part).

Example 20. The method of using any of the apparatuses or its components provided in any one or more of examples 1-17.

Example 21. The method of Example 18, further comprising using any of the apparatuses or its components provided in any one or more of examples 1-17.

Example 22. The method of manufacturing any of the apparatuses or its components provided in any one or more of examples 1-17.

Example 23. The apparatus and method of using any of examples 1-21 (as well as any subject matter disclosed herein or incorporated by reference herein), wherein the diagnosing or evaluating an animal includes any combination of at least one or more of the following: a) protein synthesis, b) gene expression, c) glucose tolerance, d) muscle hypertrophy, e) improved muscle contractile function, and f) increased width of tibia and femur, g) increased bone density, h) improved tendon structures, and i) healthy aging.

Example 24. A non-transitory machine readable medium including instructions for diagnosing or evaluating an animal, which when executed by a machine, causes the machine to perform any of the steps or activities disclosed herein.

### REFERENCES

The devices, systems, apparatuses, compositions, computer program products, non-transitory computer readable medium, and methods of various embodiments of the invention disclosed herein may utilize aspects disclosed in the following references, applications, publications and patents and which are hereby incorporated by reference herein in their entirety (and which are not admitted to be prior art with respect to the present invention by inclusion in this section).

1. Neto, W., et al., “Vertical Climbing for Rodent Resistance Training: a Discussion about Training Parameters”, Int'l. Jrnl. Of Sports Science 2016, 6 (1A): 36-49.

2. Fluckey, J., et al., “A rat resistance exercise regimen attenuates losses of musculoskeletal mass during hindlimb suspension”, Acta Physiol. Scand. 2001, 176, 293-300.

3. Barr, K., et al., “Phosphorylation of p70^{S6k} correlates with increased skeletal muscle mass following resistance exercise”, Am. Jrnl. Physiol 276: C120-C127.

4. Tamaki, T., et al., “A weight-lifting exercise model for inducing hypertrophy in the hindlimb muscles of rats”, Med. Sci. Sports Exerc. 24: 881-886.

5. Yarasheski, K., et al., “Effect of heavy-resistance exercise training on muscle fiber composition in young rats”, J. Appl. Physiol., 1988, 69: 434-437.

6. Always, S., et al., “Regionalized adaptations and muscle fiber proliferation in stretch-induced enlargement”, J. Appl. Physiol., 1989, 66: 771-781.

7. Wong, T., et al., “Skeletal muscle enlargement with weight-lifting exercise by rats”, J. Appl. Physiol., 1988, 65:P 950-954.

8. Lee, S., et al., “Viral expression of insulin-like growth factor-I enhances muscle hypertrophy in resistance-trained rats”, J. Appl. Physiol. 96: 1097-1104, 2004.

9. Lee, S., et al., “Viral expression of insulin-like growth factor-I enhances muscle hypertrophy in resistance-trained rats”, Corrigendum—J. Appl. Physiol 96: 2343, 2004.

10. Goldberg, A., “Protein Synthesis During Work-Induced Growth of Skeletal Muscle”, J. Cell Biology, 1968, 36:653-658.

11. Wirth, O., et al., “Control and Quantitation of voluntary weight-lifting performance of rats”, J. Appl. Physiol. 95: 2003, 402-412.

12. Nicastro, H., et al., “Effects of leucine supplementation and resistance exercise on dexamethasone-induced muscle atrophy and insulin resistance in rats”, Nutrition 28 (2012), 465-471.

13. Nicastro, H., et al., “An Experimental Model for Resistance Exercise in Rodents”, Jm. of Biomed. Biotechnol. 2012: 457065.

14. Cui, D., et al., “A novel model of weightlifting in mice: Signaling and gene transcription responses in skeletal muscle”, Abstract, The FASEB Jrnl, April 2016, Suppl/761.6.

15. Klitgaard, H., “A model for quantitative strength training of hindlimb muscles of the rat”, J. Appl. Physiol., Bethesda, Md., 1988, 64: 1740-1745.

16. Chinese Patent Application No. CN 102669003A, “Resistance training and hindlimb muscular strength testing device for rats”, Sep. 9, 2012.

17. Google Patents Translation—Chinese Patent Application No. CN 102669003A, “Resistance training and hindlimb muscular strength testing device for rats”, Sep. 9, 2012.

18. U.S. Pat. No. 6,880,487 B2, Reinkensmeyer, et al., “Robotic Device for Locomotor Training”, Apr. 19, 2005.

19. U.S. Pat. No. 7,065,396 B2, Hampton, T., “System and Method for Non-Invasive Monitoring of Physiological Parameters”, Jun. 20, 2006.

20. Cholewa, et al., “Basic Models Modeling Resistance Training: An Updated for Basic Scientists Interested in Study Skeletal Muscle Hypertrophy”, Jrnl. Of Cellular Physiol., V229, 1148-1156.

21. Goldberg, A., et al., “Mechanism of work-induced hypertrophy of skeletal muscle”, Medicine and Science in Sports, Vol. 7, No. 3, pp. 185-198, 1975.

22. Dela Cruz, C., et al., “Effects of Nandrolone Decanoate and Resistance Exercise on Skeletal Muscle in Adult Male Rats”, Int. J. Morphol., 30(2): 613-620, 2012.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the claims and disclosure, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. A feeding and weight resistance apparatus for an animal, said apparatus comprises:
a platform configured to move in response to lifting force exerted by the animal onto the platform;
a food repository including at least one surface, said food repository configured to store food; and
a feeding interface configured to:
impair food to be dispensed in response to retrieval force exerted by the animal, and
regulate food dispensed from said food repository for a predetermined duration in response to the lifting force exerted by the animal toward said platform.

2. The apparatus of claim 1, wherein said platform is configured to receive the head of the animal to further define said feeding interface.

3. The apparatus of claim 2, wherein said at least one surface of said food repository includes a feeding surface to further define said feeding interface, wherein said feeding surface of said food repository comprises one or more apertures for receiving the mouth of the animal and dispensing food to the animal.

4. The apparatus of claim 3, further comprises a collar configured to receive the head of the animal configured to be worn by the animal, wherein said collar further defines said feeding interface.

5. The apparatus of claim 2, further comprising a housing having at least one surface to contain the animal.

6. The apparatus of claim 5, wherein said at least one surface of said housing includes an access area for the animal to have access to said food repository.

7. The apparatus of claim 6, wherein said access area of housing includes a feeding surface to further define said feeding interface, wherein said feeding surface of said access area comprises one or more apertures for receiving the mouth of the animal and for dispensing food to the animal.

8. The apparatus of claim 6, wherein said access area includes a feeding vent.

9. The apparatus of claim 8, wherein said access area of said feeding vent includes a feeding surface to further define said feeding interface, wherein said feeding surface of said access area comprises one or more apertures for receiving the mouth of the animal and for dispensing food to the animal.

10. The apparatus of claim 2, wherein said dispensing of food is inhibited if weight of food dispensed is outside a specified weight range or if rate of food dispensed is outside a specified rate range.

11. The apparatus of claim 2, wherein said dispensing of food is inhibited if duration is outside a specified time range.

12. The apparatus of claim 1, further comprising a food supplier device configured to advance food to said food repository or said feeding interface.

13. The apparatus of claim 12, further comprising a processor for controlling the supplier device.

14. The apparatus of claim 13, further comprising a processor for controlling said feeding interface.

15. The apparatus of claim 1, further comprising a sensor, said sensor configured to detect the movement of the platform in response to the lifting force exerted by the animal onto said platform.

16. The apparatus of claim 1, wherein said animal is a mouse.

17. The apparatus of claim 1, further comprising additional weight force applied to said platform generally opposite of said lifting force.

18. A method of feeding and applying weight resistance for an animal, said method comprises:
allowing the animal to lift a platform configured to move in response to lifting force exerted by the animal onto the platform;
storing food in a food repository; and
allowing the animal to interface with the food repository such that:
food retrieval force exerted by the animal on food to be dispensed by the food repository is impaired, and
food dispensed from said food repository is regulated for a predetermined duration in response to the lifting force exerted by the animal toward said platform.

19. A method of diagnosing or evaluating an animal, said method comprising:
providing the animal to an apparatus comprising the apparatus of claim 1;
allowing the animal to use the apparatus of claim 1; and
diagnosing or evaluating the effect of the animal due to the animal using the apparatus of claim 1.

20. The method of claim 19, wherein the diagnosis or evaluating includes any combination of at least one or more of the following:
a) protein synthesis,
b) gene expression,
c) glucose tolerance,
d) muscle hypertrophy,
e) improved muscle contractile function, and
f) increased width of tibia and femur,
g) increased bone density,
h) improved tendon structures, and
i) healthy aging.
